(19) United States
(12) Patent Application Publication
(10) Pub. No.: US 2007/0278921 A1
(43) Pub. Date: Dec. 6, 2007

(54) Dischanrge lamp with outer electrodes on a printed circuit board

(75) Inventors: Hans-Gerhard Burzele, Herbrechtingen (DE); Reinhard Lecheler, Neuburg/Donau (DE)

Correspondence Address: OSRAM SYLVANIA INC, 100 ENDICOTT STREET, DANVERS, MA, 01923, US

(73) Assignee: Patent-Treuhand-Gesellschaft fur elektrische Gluhlampen mbH, Munchen (DE)

(21) Appl. No.: 11/806,313

(22) Filed: May 31, 2007

(30) Foreign Application Priority Data
Jun. 2, 2006 (DE) 10 2006 025 944.0

(51) Int. Cl. H01J 61/52; H01J 5/50

(52) U.S. Cl. 313/44; 313/318.12; 313/495

(57) ABSTRACT

A lighting system has a discharge lamp (2), and an associated electronic ballast (1), a printed circuit board (3) on one side bearing outer electrodes for the discharge vessel (5, 6, 7) and on the other side being used for mounting the ballast (1).

### TECHNICAL FIELD

The present invention relates to a lighting system having a discharge lamp and an electronic ballast for supplying the discharge lamp. In this case, the discharge lamp has outer electrodes, i.e. electrodes fitted outside the actual discharge vessel and separated from the discharge medium by the discharge vessel walls.

### BACKGROUND ART

Discharge lamps with outer electrodes are known per se. They occur in particular as a special type of discharge lamps designed for so-called dielectrically impeded discharges, in the case of which at least the anodes are separated from the discharge medium by a dielectric layer and the discharge medium generally contains noble gases and is free of mercury. Noble-gas excimers play a significant role in the generation of UV radiation, it being possible for such lamps to be in the form of both UV radiators and fluorescent lamps for the visible range.

In some cases, the electrodes, for this purpose, are fitted to the inner walls of the discharge vessel and coated with an additional dielectric layer. In other cases, which are of interest here, the electrodes are positioned outside the discharge vessel, and the discharge vessel wall forms the dielectric layer.

However, the invention relates not only to mercury-free discharge lamps with outer electrodes, although these are preferred, but quite generally to correspondingly designed discharge lamps with mercury-containing discharge media as well.

In the case of the discharge lamps designed for dielectrically impeded discharges with noble-gas excimers, a special electric pulsed operation is possible in order to achieve a high degree of efficiency, which is known per se and is familiar to a person skilled in the art. In this case, electronic ballasts are required for generating the pulses. In discharge lamps in general, electronic ballasts are at least very advantageous since, in principle, they can achieve power advantages in the lamp.

### DISCLOSURE OF THE INVENTION

The invention is based on the technical problem of specifying a lighting system which comprises a discharge lamp with outer electrodes and an electronic ballast and which is improved as regards the interaction between the discharge lamp and the ballast.

For this purpose, the invention provides a lighting system having a discharge lamp with electrodes positioned on the outside on a discharge vessel and an electronic ballast for the electrical supply to the discharge lamp which is connected to the electrodes, wherein the electrodes are conductor tracks on a printed circuit board, which is fitted to the discharge vessel, and the electronic ballast is mounted on the same printed circuit board.

The basic concept of the invention consists in achieving progress in the integration of the discharge lamp and the ballast. For this purpose the ballast is intended to be mounted on a printed circuit board, which at the same time contains, in the form of conductor tracks, the outer electrodes or at least some of the outer electrodes of the discharge lamp. In this form, particularly simple and, owing to the optional possibility of using standardized industrial products, i.e. standard printed circuit boards, particularly cost-effective and perfected technology for outer electrodes can be used, which at the same time produces the connection to the electronic ballast.

For this purpose the printed circuit board can simply be laid onto the discharge vessel directly or indirectly from the outside. In particular, as is preferred in the context of this invention, it can be adhesively bonded indirectly or directly to the discharge vessel. With an adhesive bond it is possible for a sufficient hold or an additional hold to be produced in a simple manner. Since important construction types of discharge lamps for dielectrically impeded discharges can reach considerable lengths in at least one dimension, contact which is sufficient over this length or a sufficient degree of local proximity between the electrodes and the discharge vessel can be ensured by an adhesive bond. In this case, the adhesive bonding does not rule out other fixing measures and may also be used in addition to them. Only in lamps having a relatively small format may it also be advantageous to dispense with an adhesive bond in order to eliminate the additional dielectric layer in the form of the adhesive. There is often a fundamental interest in relatively small thicknesses of the (total) dielectric layer between the outer electrodes and the discharge medium. Since the discharge vessel walls require a certain minimum thickness for mechanical reasons, there is often interest in avoiding an additional dielectric layer thickness. However, an adhesive layer may also be designed to be very thin.

A further preferred measure precisely for lamps which have a large format at least in one dimension consists in an elastic and conductive layer between the electrodes and the discharge vessel. This interlayer can be cut to the electrode geometry and therefore to a certain extent can thicken the electrodes elastically. A certain amount of compensation in the case of small bending tolerances can thus be produced, i.e. bearing against the discharge vessel by the elastic interlayer can be ensured, which, owing to its conductivity, to a certain extent represents a continuation of the electrodes in the direction towards the discharge vessel.

An application case which is of importance precisely also as regards the large-format applications and is particularly preferred for this invention is in the sector of so-called flat radiators, in which the discharge vessel is designed to be similar to a plate. It therefore has a relatively small thickness in the third dimension in comparison with its extent in two dimensions. The lamps are often rectangular lamps, for example for backlighting monitors or else for general lighting in formats which may be relevant in particular in the sector of flat screens for home cinema and television applications.

It has already been mentioned that, in addition or as an alternative to an adhesive bond, other fixing techniques can also be used. Preferred are clip systems, which are illustrated in more detail in the exemplary embodiment. In this case, the discharge vessel is held on the printed circuit board or the printed circuit board is held on the discharge vessel by means of elastic clips. Such clip constructions are simple and inexpensive and, precisely also in the case of positional deviations occurring as a result of bends or measurement tolerances, are flexible and reliable.

In the case of such a clip system for the discharge vessel and the printed circuit board, another flat device can also be fitted on the light-emitting side of the discharge vessel, in addition, for example a diffuser for improving the homogeneity of the light emission or another optically directing, focusing or shading device, or else a shield for improving electromagnetic compatibility (EMC). In this case, additional clips, as it were on another tier, but also the same clips as for the connection between the printed circuit board and the discharge vessel can be used.

According to the invention, the printed circuit board may be essentially rigid, i.e. may be designed to have an intrinsic stability, which is relevant for the mechanical construction of the lighting system according to the invention, as regards bending strength, or else to be flexible. In the flexible case, sufficient stability can also be produced by an additional support, if this is required. However, clips which are also fitted to the discharge vessel, for example, can hold a flexible printed circuit board. A flexible printed circuit board can be matched particularly well to deviations from a flat design or to measurement or bending tolerances and is particularly thin.

On the other hand, rigid printed circuit boards have the advantage that they themselves can be used as a mechanical holder. In particular they can be designed as a mechanical holder for the electronic ballast, and can connect the electronic ballast mechanically to the lamp.

The mounting according to the invention of the ballast on the printed circuit board may, on the one hand, be purely mechanical in nature, for example in the form just mentioned, with the result that a ballast housing, for example, is held mechanically by a rigid printed circuit board. However, it may also be electrical in nature by the electronic components or at least some of the electronic components of the ballast being mounted electrically on the printed circuit board. Naturally, in particular in the case of rigid printed circuit boards, both aspects can be combined.

Finally, the lighting system according to the invention may have a metallic cooling face for cooling the printed circuit board and the discharge vessel on a side which faces away from the discharge vessel. This cooling face may be in the form of a continuous metallic layer on the printed circuit board, i.e. of a double-metallized printed circuit board. It may also be a further piece of sheet metal. In particular, according to the invention, a cooling plate may be provided which is spaced apart, preferably areally at essentially the same distance from the discharge vessel and the printed circuit board and therefore predetermines a consideration of a required minimum distance for sufficient cooling in a manner which is necessary in design terms for the installation of the lighting system. To illustrate this, reference is made to the exemplary embodiments.

### BRIEF DESCRIPTION OF THE DRAWINGS

FIG. 1 shows a schematic sectional illustration of a lighting system according to the invention as a first exemplary embodiment.

FIG. 2 shows an illustration corresponding to FIG. 1 of a second exemplary embodiment.

FIG. 3 shows an illustration corresponding to FIG. 1 of a third exemplary embodiment.

FIG. 4 shows an illustration corresponding to FIG. 1 of a fourth exemplary embodiment.

FIG. 5 shows an illustration corresponding to FIG. 1 of a fifth exemplary embodiment.

FIG. 6 shows a schematic plan view of the fifth exemplary embodiment shown in FIG. 5.

### BEST MODE FOR CARRYING OUT THE INVENTION

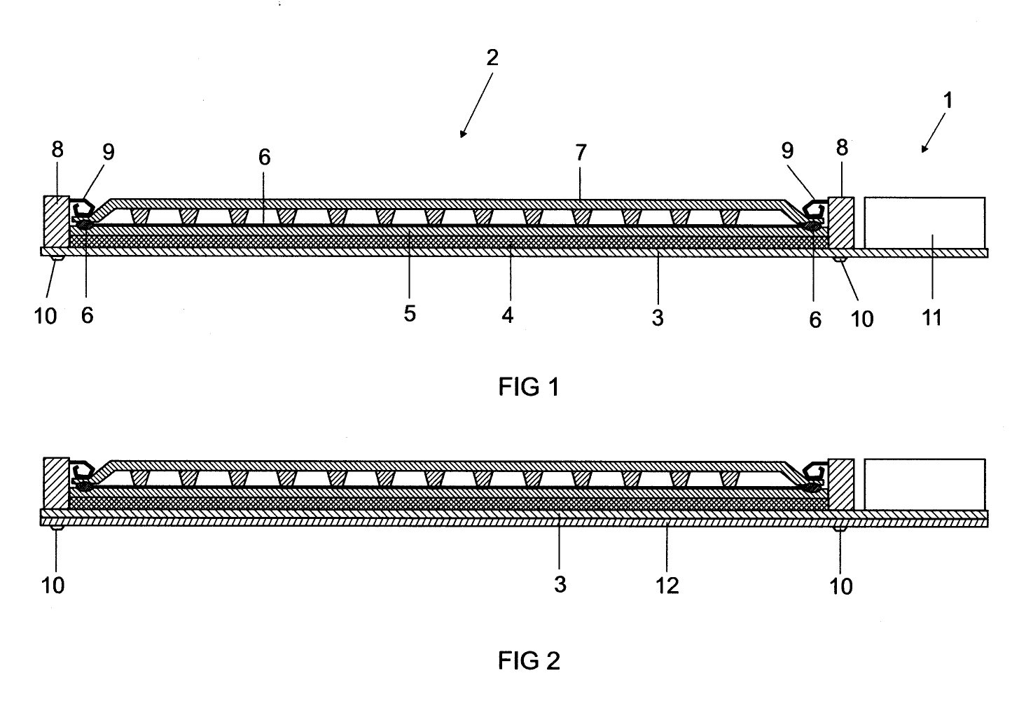

FIG. 1 shows, in a schematic sectional illustration, a lighting system according to the invention having an electronic ballast, which is denoted by way of summary by 1, and a discharge lamp, which is denoted by way of summary by 2. The electronic ballast and the discharge lamp are mounted together on a printed circuit board 3, to be precise on the same side, which points upwards in FIGS. 1-5, next to one another.

The printed circuit board 3 consists of a glass-fiber-reinforced plastic material (FR4 printed circuit board) and has a thickness of approximately 0.5 mm. By means of generally known lithography and etching techniques, conductor tracks, which are designed as strip-shaped electrodes for the lamp and are not illustrated in any more detail here, are provided on the lamp-facing upper side of the printed circuit board 3. The typical electrode structures for discharge lamps which are designed for dielectrically impeded discharges, as is the case here, are known from the literature.

In the region of the lamp 2, an interlayer 4, which may be an adhesive layer in one variant, an elastic conductive layer with the basic structure of the electrodes in another variant (in the plane which is at right angles to the plane of the drawing and intersects it horizontally), is then provided over the printed circuit board 3. The figure is not to scale; in fact the layer thickness of the layer 4 is considerably smaller, even smaller than the thickness of the printed circuit board 3.

The adhesive layer and the elastically conductive layer do not rule one another out. Finally, elastic adhesives, even non-conductive ones, are also conceivable, for example silicone or polyurethane and hot-melt adhesives. If problems associated with thermal stress occur, the printed circuit board 3 could also be provided with compensating slits.

The lower flat glass plate 5 of the discharge vessel of the lamp 2 is then provided over the interlayer 4. This lower flat glass plate 5 is connected to an upper glass plate 7 of the discharge vessel of the lamp 2 in the outer region via a glass solder edge layer, denoted by 6 in the figure. Reference is made to U.S. Pat. No. 6,762,549 for the design of the discharge vessel, which essentially comprises the two glass plates 5 and 7 and the glass solder edge 6.

The outer edge of the discharge vessel 5, 6, 7 is surrounded and, together with the interlayer 4, bordered by a frame strip 8, which constitutes approximately the total height of the components 4-7. In the upper region, elastic sheet-metal clips 9, which press onto the upper edge of the upper plate 7 of the discharge vessel and push it onto the printed circuit board 3, together with the interlayer, are fixed to said frame strip 8. In turn, the frame strip 8 is fixed to the printed circuit board 3 by fixing elements 10, which pass through the printed circuit board 3 from below.

In the right-hand region of FIG. 1, the electronic ballast 1 is illustrated simply as a rectangle, or in three-dimensional terms as a parallelepiped. In fact, the parallelepiped is a metallic shielding housing 11 of the electronic ballast which surrounds the electronic components (not illustrated individually here) thereof and shields them with a connection to ground. The electronic components are mounted within the housing 11 on the printed circuit board 3, with the result that the conductor tracks acting as electrodes on the printed circuit board 3 directly produce the electrical connection to the electronic ballast 1. In this exemplary embodiment, the rigid printed circuit board 3 in addition also acts as a mechanical holder for the electronic ballast 1.

The second exemplary embodiment in FIG. 2 corresponds, firstly in terms of the description relating to reference symbols 1-11, to the abovementioned explanations relating to the first exemplary embodiment in FIG. 1. These explanations are not repeated here; FIG. 2 also does not include these reference symbols again. In addition, a cooling plate 12 on the lower side, i.e. the side facing away from the lamp, of the printed circuit board 3 is provided here, which cooling plate 12 is connected to the printed circuit board 3 and the frame strip 8 via the same fixing elements 10 which produce the connection between the printed circuit board 3 and the frame strip 8 in FIG. 1. The cooling plate can also be used for mechanically reinforcing the printed circuit board 3; in particular the printed circuit board 3 can in this case be in the form of a flexible thin printed circuit board without the possibilities for holding the electronic ballast 1 on a common platform with the lamp 2 being restricted.

As has already been mentioned at an earlier point, the cooling function can also be provided by a lower-side metallization of the printed circuit board 3, with the result that the layer 12 in FIG. 2 can also be envisaged as a slightly thicker metal layer (not illustrated to scale) on the lower side of the printed circuit board 3.

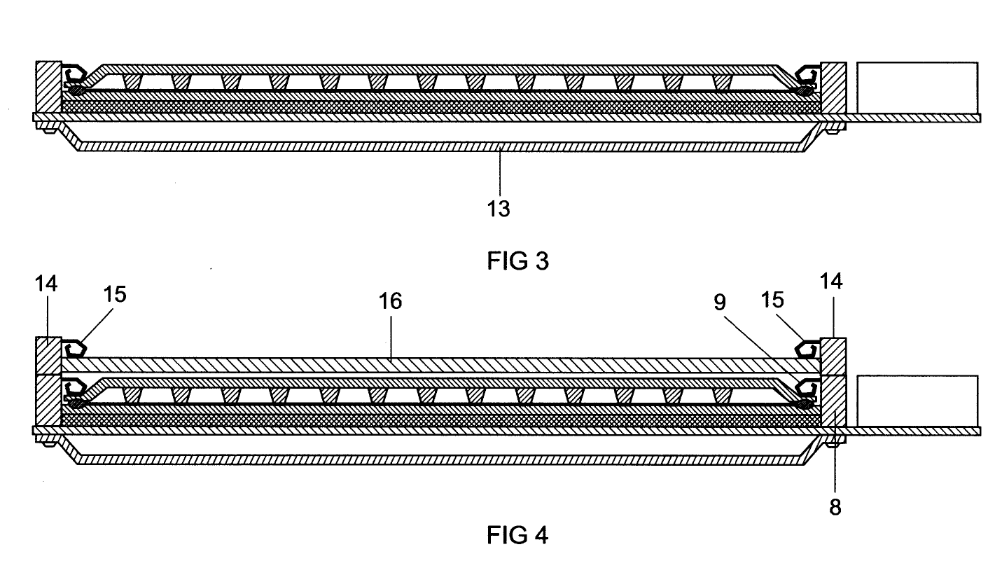

The third exemplary embodiment in FIG. 3 in turn corresponds to the first exemplary embodiment in FIG. 1 as regards the explanations relating to the reference symbols 1-11. In contrast to the second exemplary embodiment in FIG. 2, in this case the cooling plate is designed geometrically differently and is therefore denoted by 13. The cooling plate 13 has a slightly curved design, only the outermost edge being bent and the central region remaining flat. As a result, the cooling plate 13 keeps a distance from the printed circuit board 3, which can act as a cooling chimney. It is therefore ensured merely by design measures that the lighting system according to this third exemplary embodiment can be constructed at not too short a distance from other components and therefore not with a restricted cooling function in the case of an installation, for example, in a monitor.

The fourth exemplary embodiment in FIG. 4 in turn corresponds to the explanations relating to the first exemplary embodiment as regards the reference symbols 1-11 and also to those relating to the third exemplary embodiment as regards the reference symbol 13. In addition, in comparison to the three preceding exemplary embodiments, the frame strip 8 with the clips 9 is in this case extended by a further frame strip 14 with further clips 15. With these additional clips, a further flat device can be fixed over the discharge vessel 5, 6, 7, i.e. upstream of its light-emitting side, between these additional clips and the clips 9 lying therebeneath or another stage in the frame strip 14 or the frame strip 8. This other flat device is a diffuser 16 i.e. a planar-parallel, translucent plate with light-diffusing or light-scattering properties.

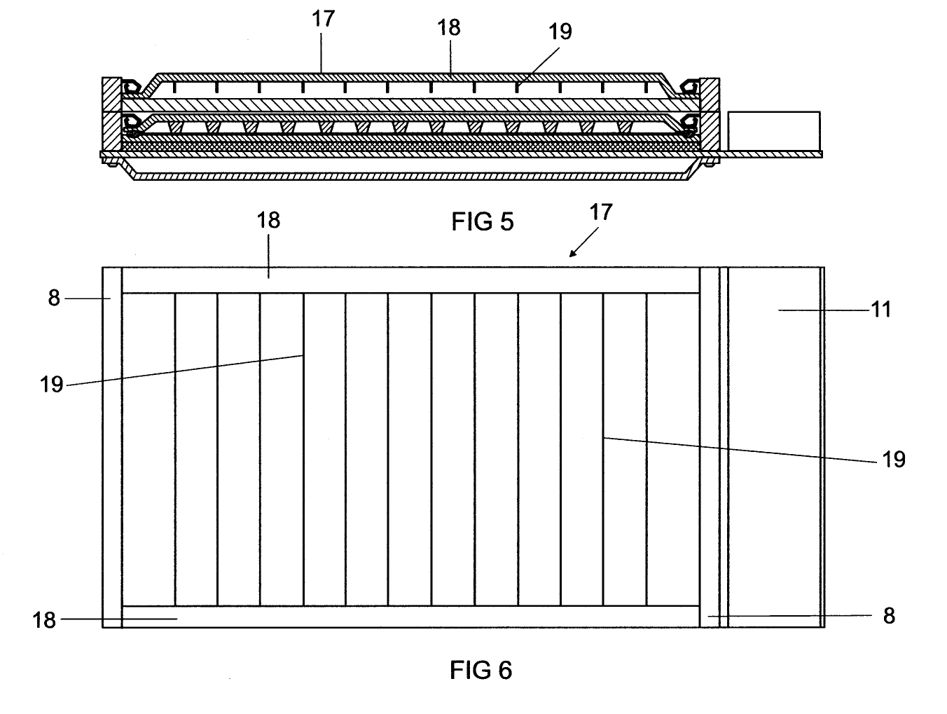

The next fifth exemplary embodiment in FIG. 5 corresponds to the fourth exemplary embodiment in FIG. 4, with the only difference that, in this case, a grating construction for improving the electromagnetic compatibility (EMC) is also provided here in addition to the diffuser 16, which grating construction is overall denoted by 17. This EMC shielding construction 17 also becomes clearer from the plan view in FIG. 6 of the fifth exemplary embodiment in FIG. 5. It can be seen that the EMC shield 17 comprises essentially vertically aligned grating laminates 19, which are set on edge-side strips 18 and are held over these by the clips 15. The clips 15 ground the EMC shield 17, with the result that it reduces the high-frequency radiation from the discharge vessel 5, 6, 7 at the top. The frame strips 8 are not illustrated to scale in FIG. 6.

Moreover, metallization of the printed circuit board 3 covering the entire area or else grounded cooling plates 12 or 13 can result in similar EMC shielding at the bottom.

The invention has the advantage that the electrode structure and the electrode isolation can be achieved in a simple and proven manner by a standard product which is conventional in the industry. In this case, the thermal resistance, issues concerning contact-making, the dielectric strength and other technical issues have long been known and tested for conventional printed circuit boards. The conductor track structures themselves can be reproduced very easily and have tight tolerances, with the result that homogeneity problems owing to fluctuations in the electrode width do not apply. The adhesion problems occurring in conventional silver tracks on glass are of no concern in this case. A double-sided printed circuit board with an additional lower-side metal layer for cooling and additional shielding results in virtually no additional complexity. Furthermore, conventional plug-in connections can also be mounted directly and in a manner which has been known for a long time on a printed circuit board.

Finally, a solution with a printed circuit board on the discharge vessel also makes it possible to additionally make contact on the rear side or to produce a through-plating in the printed circuit board. The electronic ballast could therefore also be fitted on the side of the printed circuit board which points downwards in the figures, or other additional parts could be mounted there. With through-platings individual regions of the lamp could also be connected or disconnected separately by means of corresponding electronic driving.

1. A lighting system having
a discharge lamp with electrodes positioned on the outside on a discharge vessel,
and an electronic ballast for the electrical supply to the discharge lamp which is connected to the electrodes,
wherein the electrodes are conductor tracks on a printed circuit board, which is fitted to the discharge vessel, and the electronic ballast is mounted on the same printed circuit board.

2. The lighting system as claimed in claim 1, in which the printed circuit board is fitted to the discharge vessel by means of adhesive bonding.

3. The lighting system as claimed in claim 1, in which an electrically conductive interlayer is provided between the electrodes on the printed circuit board and the discharge vessel.

4. The lighting system as claimed in claim 1, in which the discharge vessel is in the form of a flat radiator.

5. The lighting system as claimed in claim 1, in which the discharge vessel and the printed circuit board are connected via clips.

6. The lighting system as claimed in claim 5, in which a flat device, in particular a diffuser or an EMC shield, is fitted on the light-emitting side of the discharge vessel and is connected to the discharge vessel via clips.

7. The lighting system as claimed in claim 1, in which the printed circuit board is rigid and is in the form of a mechanical holder for the electronic ballast.

8. The lighting system as claimed in claim 1, in which electronic components of the electronic ballast are mounted on the printed circuit board.

9. The lighting system as claimed in claim 8, in which the printed circuit board is flexible.

10. The lighting system as claimed in claim 1, in which a metallic cooling face for cooling the printed circuit board and the discharge vessel is provided on a side of the printed circuit board which faces away from the discharge vessel.

11. The lighting system as claimed in claim 10, in which a cooling plate, which is spaced apart from the printed circuit board, is provided as the cooling face.

12. The lighting system as claimed in claim 2, in which the printed circuit board is rigid and is in the form of a mechanical holder for the electronic ballast.

13. The lighting system as claimed in claim 3, in which the printed circuit board is rigid and is in the form of a mechanical holder for the electronic ballast.

14. The lighting system as claimed in claim 4, in which the printed circuit board is rigid and is in the form of a mechanical holder for the electronic ballast.

15. The lighting system as claimed in claim 5, in which the printed circuit board is rigid and is in the form of a mechanical holder for the electronic ballast.

16. The lighting system as claimed in claim 6, in which the printed circuit board is rigid and is in the form of a mechanical holder for the electronic ballast.
